(19) United States
(12) Patent Application Publication
(10) Pub. No.: US 2007/0258722 A1
(43) Pub. Date: Nov. 8, 2007

(54) OPTICAL RECEIVER

(76) Inventor: Jin Yu, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/745,986

(22) Filed: May 8, 2007

Related U.S. Application Data
(60) Provisional application No. 60/798,400, filed on May 8, 2006.

(51) Int. Cl. H04B 10/06

(52) U.S. Cl. 398/212

(57) ABSTRACT

An optical receiver for enhanced optical power sensitivity for optical signal at 10 Gbps includes an optical package and a supporting electrical circuitry. The optical package includes a semiconductor optical amplifier to pre-amplify the incoming weak signal, a tunable optical filter to suppress the spontaneous noise of the amplifier and a PIN diode as an optical detector. A supporting electrical circuitry includes a control loop for the filter to track the peak of the optical signal. By optimizing the parameters of all the elements, the final sensitivity of the optical receiver can be increased significantly. The device may be realized in a single package.

### CROSS-REFERENCE TO RELATED APPLICATIONS

This application claims priority to U.S. Provisional Application No. 60/798,400, filed May 8, 2006, which is incorporated herein by reference in its entirety.

### TECHNICAL FIELD

The present disclosure relates generally to receivers for fiber optic communications.

### BACKGROUND

With the progress of data communication over optical fiber links, both the data rate and transmission distance are increasing. Currently, 10 gigabits per second (Gbps) is becoming more popular for a transmission data rate as an upgrade from systems working at 2.5 Gbps. It may be used in field deployment for backbone networks as well as for local data access networks. Increasing sensitivity for optical receivers at 10 Gbps is always desired. For example, optical receiver detectivity for 2.5 Gbps is about −32 dBm. As many systems at 2.5 Gbps are upgraded to 10 Gbps, one concern is weak sensitivity of the optical receiver at 10 Gbps. The best current optical receiver sensitivity is about −26 dBm, i.e., about 6 dB worse than at 2.5 Gbps. A conventional solution to make the receiver capable of detecting weaker optical signals may be to put an additional erbium-doped fiber amplifier (EDFA) to pre-amplify the signal. An optical detector may then be capable of detecting the amplified signal. However, an EDFA may typically be a large device, i.e., a rack mounted package requiring a 19 inch wide cabinet slot or a “blade” mounted board inserted in a rack assembly. Therefore, there is a need for a compact optical receiver solution to increase the detection capability of the optical signal.

### SUMMARY

Systems and methods are disclosed herein to provide a compact optical receiver solution to increase the detection capability of the optical signal. For example, in accordance with an embodiment, a sensitivity enhanced optical receiver includes an optical amplifier, a tunable optical filter, a diode optical detector, and a trans-impedance amplifier.

In accordance with another embodiment, a optical receiver system includes a sensitivity enhanced optical receiver, a thermoelectric cooler, and a supporting circuit to track the optical peak of the signal and adjust the temperature of the thermoelectric cooler, wherein the central wavelength of the tunable optical filter is temperature tunable and is maintained at the peak of the optical signal by adjusting the temperature.

The scope of the disclosure is defined by the claims, which are incorporated into this section by reference. A more complete understanding of embodiments will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a block diagram illustrating sensitivity enhanced optical receiver in accordance with an embodiment.

FIG. 2 shows an embodiment of the sensitivity enhanced optical receiver in a butterfly package.

FIG. 3 shows a block diagram illustrating an optical receiver system in accordance with an embodiment.

Embodiments and their advantages are best understood by referring to the detailed description that follows. It should be appreciated that like reference numerals are used to identify like elements illustrated in one or more of the figures.

### DETAILED DESCRIPTION

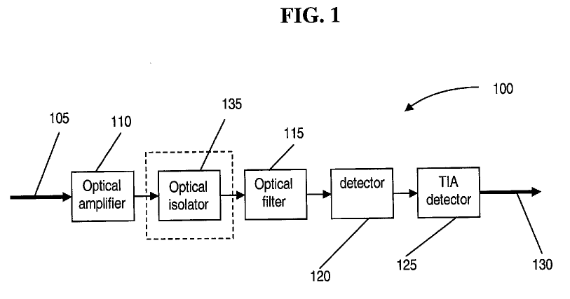

FIG. 1 is a block diagram of a sensitivity enhanced optical receiver (SEOR) 100 according to one embodiment. An optical signal 105 may be provided via an optical fiber connector (not shown) to the input of an optical amplifier 110. Various optical amplifiers are known in the art, such as an erbium doped fiber amplifier; however a semiconductor optical amplifier (SOA) may be preferred because the small size may permit implementation with several other miniature optical components in a single package.

The output of optical amplifier 110 may be input to an optical filter 115. Optical filter 115 may be implemented as a thin film Fabry-Perot filter to pass a narrow bandwidth of wavelengths, thus reducing any out-of-band optical signal that may be generated by, for example, optical filter 115 or signals on other carrier wavelengths. Filtering the amplified signal in this manner improves the optical signal-to-noise-ratio (OSNR), thus limiting the amount of noise introduced in the system and improving the purity and bit-error rate of the signal. Optical filter 115 can be configured to have the maximum of its bandwidth centered at the optical signal of interest. Since it may occur that many optical wavelength channels are available, it may be desirable for optical filter 115 to be made tunable over a range of wavelengths and may be implemented in various ways.

One method of tuning optical filter 115, for example, assuming the filter is a fixed thin film device, depends on the fact that such thin film devices are sensitive to temperature. Therefore, sensitivity enhanced optical receiver 100, or only optical filter 115 portion of receiver 100, may be mounted on a thermoelectric heater (described below) that may be controlled to change and control the temperature of optical filter 115 according to a known dependence of peak wavelength transmission vs. wavelength. In this way, sensitivity enhanced optical receiver 100 can be used to track a single wavelength optical signal or switch to another wavelength and track it in the same manner. Alternatively, optical filter 115 may be dynamically tuned and implemented with micro-electromechanical system (MEMS) technology. For any type of Fabry-Perot optical filter, the selectivity is specified by the free spectral range (FSR), which describes the passband bandwidth and separation between successive passbands. The FSR is designed to satisfy the requirements for processing 10 Gbps signals. The FSR may depend, typically, at least on the reflectivity of surfaces or layers in a multi-layer structure, cavity length, mode control, and absorption in the materials through which the light signal passes.

The output of optical amplifier 110 may optionally first be input to an optical isolator 135. Optical isolator 135 functions to prevent reflection of the forward transmitted optical signal backwards in an optical system. In this case, a reflection of the amplified signal from optical amplifier 110 back to optical amplifier 110 may cause unstable oscillation in the output of optical amplifier 110, a common occurrence in such gain systems, which is avoided by introduction of optical isolator 135.

The output of optical filter 115 may be the input to a detector 120. Various detectors are known in the art. For example, detector 120 may be a PIN diode. A PIN diode is a diode with a wide, undoped intrinsic semiconductor region between p-type semiconductor and n-type semiconductor regions. They are not limited in speed by the capacitance between n and p region anymore, but by the time the electrons need to drift across the undoped region. Thus, PIN diodes may be made sufficiently fast to perform at 10 Gbps. Alternatively, avalanche photodiodes (APDs) may be used as detector 120. APDs are photodetectors that may be reversed biased to provide significant gain (>100) and high speed sufficient to meet the requirements of 10 Gbps communications.

The output of detector 120 may be a trans-impedance amplifier (TIA) 125. TIA 125 may provide the gain required and output an electrical signal 130 at an impedance level compatible with electronic signal processing.

Sensitivity enhanced optical receiver 100 may often deal with optical signals of very low optical power at 10 Gbps. This power level may be well below the sensitivity power of APDs at 10 Gbps, which, for conventional devices, is considered to be about −26 dBm (i.e., 26 dB below 1 mW of optical power). The signal 105 of low optical power may be first fed to semiconductor optical amplifier 110 to boost its power. Semiconductor optical amplifier 110 may be a Fabry-Perot semiconductor laser with anti-reflection coating on both end of the cavity. Because of the absence of high reflectivity end coatings, there is no lasing. In addition, semiconductor optical amplifier 110 may be polarization independent. In order to make the amplification range stable, a thermoelectric heater/cooler (not shown) may be used to hold the amplifier device at a fixed temperature to maintain stable output.

The output from semiconductor optical amplifier 110 may then be adjusted to be in an acceptable dynamic range of the photo detector. Because of the gain of semiconductor optical amplifier 110, the output power may be higher than the minimum requirement of PIN detector 120. Therefore, a PIN device can be used for low cost. An APD may generally be more expensive, which may increase the cost of receiver 100 significantly.

In order to improve the detected signal-to-noise-ratio, optical filter 115 is used to block the broadband amplified spontaneous emission. The electrical output of photo detector 120 is fed to a trans-impedance amplifier to maximize signal integrity of the output from the detector.

The following example illustrates how sensitivity enhanced optical receiver 100 can realize power sensitivity. Current commercially available optical APD detectors have power sensitivity superior to PIN diodes, but are generally more costly. APDs may satisfy a minimum power requirement of −26 dBm for a 10 Gbps signal, which is a typical required input optical power level to support a bit error rate (BER) of less than 1 e-12. In order to realize substantially error free transmission (i.e., BER<1 e-15), the optical power level should be at least 2 or 3 dB higher. If the receiving optical signal 105 power is lower than −26 dBm, it may be necessary to first amplify optical signal 105 before outputting it to detector 120. Another requirement may be to have a sufficient OSNR.

As an example, assume semiconductor optical amplifier 110 has a gain of 30 dB for a receiving optical signal 105 of −30 dBm. The output power of the signal is 0 dBm, i.e., 1 mW. To achieve minimum OSNR of 20 dB, the noise level at the resolution bandwidth of 0.1 nm should be less than −20 dBm, i.e., less than 0.01 mW. Considering that the noise spreads over a typical amplifier bandwidth range of 50 nm, the integrated noise is 0.01 mW×(50/0.1)=5 mW. Adding a signal power of 1 mW, the total power is 6 mW. This is the requirement of the semiconductor optical amplifier, 30 dB gain and 6 mW saturation power. In this case, however, the input power to the PIN may be greater than the PIN overload limit. Therefore, extra attenuation may be added before outputting optical signal to the PIN diode.

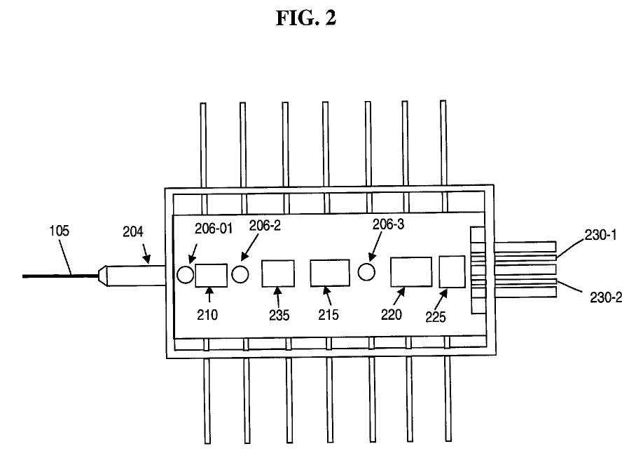

FIG. 2 is a butterfly package 200 embodiment of the sensitivity enhanced optical receiver in accordance with the disclosure. Receiver butterfly package 200 may differ from conventional butterfly packages for lasers and transmitters in that an output 230 is a differential output 230-1 and 230-2 to provide high speed is at the output of the optical receiver. Like a standard butterfly package, optical signal 105 may be admitted through a connector 204 that includes a lens (not shown) and an optical isolator (not shown). The lens may be one of various types known in the art, and may include, for example, a Selfoc™ or a ball lens. The isolator typically functions to suppress reflections back to the source or points in the transmission system where reflections might arise, thus causing signal instabilities due to laser feedback or standing waves. A 1 mm ball lens 206-1 may be used to couple input optical signal 105 from the fiber holder to semiconductor optical amplifier 210. Semiconductor optical amplifier 210 may be about 2 mm long.

At a wavelength of 1550 nm, the gain of semiconductor optical amplifier 210 may be typically about 22 dB. For example, if the input to the amplifier is −32 dBm, output power is then −10 dBm, well above the sensitivity power of a high speed PIN photodiode, which may require a signal greater than −19 dBm to operate. The optical signal may then be coupled to another isolator 235 followed by coupling to a tunable optical filter 215 with ball lens 206-2. Isolator 235 may function to suppress instability inducing reflections back into semiconductor optical amplifier 210. A typical minimized isolator is about 2 mm long with isolation beyond 30 dB. A micro-electromechanical systems (MEMS) based optical tunable filter can be used as tunable optical filter 215 here to take advantage of small size. A typical MEMS tunable Fabry-Perot (FP) filter is less than 2 mm. The 3 dB bandwidth of the filter may be about 20 GHz. The free spectral range (FSR) of tunable FP filter 215 may be comparable to the range of the broadband noise. With semiconductor optical amplifier 210, the wavelength bandwidth of the noise is typical 40 to 60 nm. With such parameters, a tunable filter may be achieved.

The output of tunable optical filter 215 may be coupled to a detector 220, which may be a PIN diode or an APD, depending on power levels and budget, through ball lens 206-3. A PIN diode detector 220 having a sub-mount of 2 mm length is commercially available. The PIN converts optical signal to electrical current. The output of the PIN is connected to a trans-impedance amplifier (TIA) chip 225, which converts current to an appropriate voltage level. TIA chips are commercially available for high speed optical photodiode impedance conversion. The length of a typical TIA chip may be about 1 mm. Furthermore, such TIA chips may commonly have differential outputs. They provide the electrical output signal of SEOR 100. The total length of the elements within butterfly package 200 may be about 14 mm, which is sufficiently less than the inside length of a butterfly package of about 20 mm.

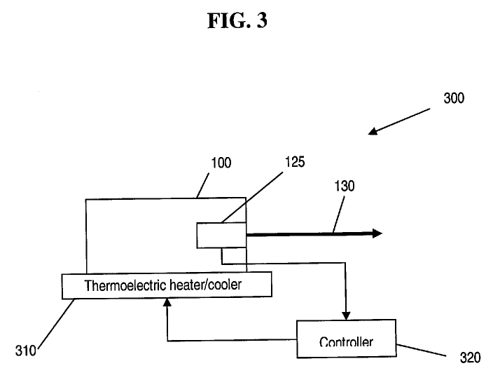

FIG. 3 shows a block diagram illustrating an optical receiver system 300 in accordance with an embodiment. Referring to FIGS. 1 and 2, optical signal 105 enters sensitivity enhanced optical receiver (SEOR) 100, where it is optically amplified, filtered, detected and trans-impedance amplified. A portion of output electrical signal 130 is monitored by a controller 320 that adjusts the power to, and therefore the temperature of, a thermoelectric heater/cooler 310. The temperature control provided by thermoelectric heater/cooler 310 adjusts the center of the passband of optical filter 115 to track the wavelength of optical signal 105 to maintain maximum signal. Other means of tuning the passband of optical filter 115 may alternatively be implemented. For example, a MEMS FP may be driven by controller 320. Additionally, if signal saturation conditions are exceeded, controller 320 may be adapted to provide attenuation to prevent overload of diode detector 120 by intentionally detuning optical filter.

Embodiments described above illustrate but do not limit the invention. It should also be understood that numerous modifications and variations are possible in accordance with the principles of the present invention. Accordingly, the scope of the invention is defined only by the following claims.

We claim:

1. A sensitivity enhanced optical receiver comprising:
an optical amplifier;
a tunable optical filter coupled to the optical amplifier;
a diode optical detector coupled to the optical filter; and
a trans-impedance amplifier coupled to the optical detector.

2. The receiver of claim 1, wherein the optical receiver is comprised in a single package.

3. The receiver of claim 1, wherein the optical amplifier is a semiconductor optical amplifier.

4. The receiver of claim 1, wherein the optical amplifier is polarization independent.

5. The receiver of claim 1, wherein the tunable optical filter is a Fabry-Perot type filter with a free spectral range and bandwidth optimized for a 10 Gbps signal.

6. The receiver of claim 1, wherein an input to the optical filter is coupled to an output from the optical amplifier.

7. The receiver of claim 1, further comprising an optical isolator coupled between the optical amplifier and the optical filter.

8. The receiver of claim 7, wherein an output of the optical amplifier is coupled to an input of the optical isolator.

9. The receiver of claim 8, wherein an output of the optical isolator is coupled to an input to the optical detector.

10. The receiver of claim 9, wherein an output of the diode detector is coupled to an input of the trans-impedance amplifier.

11. The receiver of claim 1, wherein the diode detector is at least one of a PIN diode or avalanche photodiode detector APD.

12. The receiver of claim 11, wherein the detector has a bandwidth optimized to receive a 10 Gbps signal.

13. A optical receiver system comprising:
a sensitivity enhanced optical receiver; and
a supporting circuit coupled to the optical receiver to track the peak of the optical signal and maintain the central wavelength of the optical filter at the peak of the optical signal.

14. The receiver system of claim 13, wherein the supporting circuit tracks the peak of the optical in the sensitivity enhanced optical receiver.

15. A sensitivity enhanced optical receiver comprising:
means for amplifying an input optical signal;
means for selectively filtering the optical signal;
means for detecting the optical signal and generating an electrical signal; and
means for amplifying the electrical signal.

16. The receiver of claim 15, further comprising means to prevent optical reflections back to the means for amplifying the optical signal.
